(19) United States
(12) Patent Application Publication
(10) Pub. No.: US 2017/0374315 A1
(43) Pub. Date: Dec. 28, 2017

(54) DEVICE AND METHOD FOR USING DIFFERENT VIDEO FORMATS IN LIVE VIDEO CHAT

(71) Applicant: Shenzhen Seefaa Scitech Co., Ltd., Shenzhen (CN)

(72) Inventor: Zhigang Ma, Northville, MI (US)

(21) Appl. No.: 15/700,139

(22) Filed: Sep. 10, 2017

Related U.S. Application Data
(63) Continuation of application No. PCT/CN2016/087454, filed on Jun. 28, 2016.

(51) Int. Cl. H04N 7/14; H04N 7/15; H04L 12/58; H04L 12/18; G06T 5/00

(52) U.S. Cl. CPC H04N 7/141; H04N 7/15; H04L 51/04; G06T 2207/30201; G06T 2207/10016; G06T 5/002; H04L 51/32; H04L 12/1813

(57) ABSTRACT

A device is described for bridging a live video chat between two users via two terminals. Upon a conduction that the video chat will be the first chat between the two users or that the two users have not had such a video chat for a certain period of time since last video chat, or that one user's privilege for video chatting is higher than the other user's, instructions will be send to either or both of the terminals to make non full-fledged video to be used in the video chat. The non full-fledged video refers to a video with its color or audio components altered, or captured with an altered resolution or frame per second rate.

### BACKGROUND OF THE INVENTION

### 1. Field of the Invention

The disclosure relates to social networking technology and, particularly, to a device and a method using different video formats in live video chats in social networking based on user profiles.

### 2. Description of Related Art

Live video chats are a popular way of social networking in making friends. For strangers, a regular video chat with full color and voice may be awkward for very first video chat.

To address the issue, a time-limited and brief initial video chat between two strangers would be less stressful, and furthermore, using different formats of video in the video chat based on the strangers user profiles with the chatting service would create an interesting way of chatting and encourages follow-up video chats between the two.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1 is a schematic diagram showing a overall exemplary working relationship among a device and two terminals which are connected with the device for live video chatting;

FIG. 2 is a block diagram showing functional blocks for the device of FIG. 1, in accordance with an embodiment;

FIG. 3 is a block diagram showing functional blocks for one of the two terminals of FIG. 1, in accordance with an embodiment;

FIG. 4 is a block diagram showing functional blocks for the other one of the two terminals of FIG. 1, in accordance with an embodiment;

FIG. 5 is a schematic diagram showing both user interfaces, according to one embodiment, of the two terminals of FIG. 1, when both terminals are in process of starting a live video chat;

FIG. 6 is a schematic diagram showing a user interface of one of the two terminals for accepting live video chat request, according to an embodiment;

FIG. 7 is a schematic diagram showing a user interface of one of the two terminals of FIG. 1 which represents a on-going live video chat screen, in accordance with an embodiment;

FIGS. 8A-8B are flowcharts illustrating a process in the device of FIG. 1. of conducting a first live video chat between the two terminals of FIG. 1, according to an embodiment;

FIG. 9 is a flowchart illustrating steps for making and using different formats of video in bridging a video chat under different conditions, according to an embodiment;

FIG. 10 is a flowchart illustrating steps for rendering video in different formats in bridging a video chat under different conditions, according to an embodiment;

FIG. 11 shows a process of determining how the period of time for a video chat will be decided in on embodiment;

FIG. 12 shows an exemplary flow of process to pre-record media of a user and use it before a live video chat, based on one embodiment;

FIG. 13 is a diagram showing exemplary modules and components of the camera module of one of terminals in FIG. 1 and their relations with other components of terminal;

FIG. 14 is a diagram showing exemplary modules and components of the media module of one of terminals in FIG. 1, and their relations with other components of terminal;

FIG. 15 is an exemplary flow of process based on the result of comparing the privileges of two users for a live video chat, according to an embodiment; and

FIG. 16 is a flowchart showing exemplary process of comparing privileges of two users for a live video chat, and then determining format of video to be made, according to an embodiment.

### DETAILED DESCRIPTION OF THE INVENTION

The invention will now be described in detail through several embodiments with reference to the accompanying drawings.

In general, the word “module”, as used herein, refers to logic embodied in hardware or firmware, or to a collection of software instructions, written in a programming language, such as, Java, C, Objective-C, SWIFT, scripts, markup languages, or assembly. One or more software instructions in the modules may be embedded in firmware, such as EPROM. The modules described herein may be implemented as either software and/or hardware modules and may be stored in any type of non-transitory computer-readable medium or other storage device. In other situations, a module may also include a hardware unit. The word “memory” generally refers to a non-transitory storage device or computer-readable media. Some non-limiting examples of non-transitory computer-readable media include CDs, DVDs, BLU-RAY, flash memory, and hard disk drives.

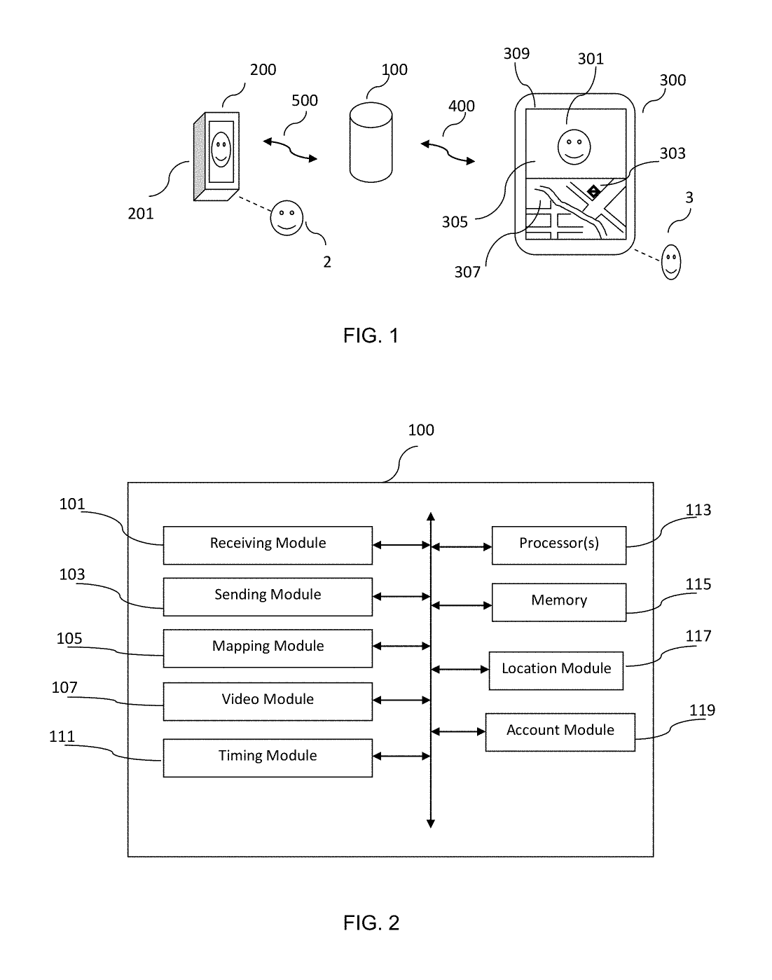

Referring to FIG. 1, an overall architecture of live video chat system are illustrated by its principle, in accordance with an embodiment. A device 100, functioning as a server device, is connected to a number of terminals, being either mobile devices, such as smartphones, or other kinds of devices, such as tablets, PCs. The connections 400 and 500 can be wired or wireless, using various protocols, such as HTTP protocol, real time messaging protocol (RTMP), real time streaming protocol (RTSP), etc., running through the Internet, or local area networks, or combination of both. Here, two terminals 200, and 300 are used as exemplary terminals to illustrate the principles of the invention. A user 2 of terminal 200 can conduct live video chat with a user 3 of terminal 300, via device 100.

FIG. 2 shows functional modules and components device 100 has. In one embodiment, device 100 can have:

1. a receiving module 101 to receive requests from terminals 200 and 300, such as functioning as an event listener to listen on a certain port to receive request for conducting a live video communication, receive video streams using video stream frameworks, such as, ADOBE MEDIA SERVER, RED 5 MEDIA SERVER, and/or APACHE FLEX, etc., to get location information and other information from terminals 200 and 300;

2. a sending module 103 to transmit communication data to terminals 200 and/or 300, such as sending live video streams, the sending module 103 may include instructions for establish connections, prepare and transmit data;

3. a mapping module 105 to create and render a map in terminals 200 and/or 300, using location information got from terminal 200 or 300, tag the location into existing maps, alternatively, the mapping module 105 may just provide tagging information based on the location information, and terminals 200 and 300 may acquires basic mapping directly from a map server (not shown);

4. a video module 107 to process video data received from terminals 200 and 300, it may buffer, encode and decode according various video stream or related protocols, such as HTTP streaming, RTMP, RTSP, etc., and prepare the live video objects as needed to facilitate the video communications between terminals 200 and 300;

5. a timing module 111 to function as timer for stopping certain events or triggering certain events. e.g., for stopping an on-going live video chat session by device 100, this module contains instructions implementing clocking and timing function;

6. one or more processors 113, to execute and control the instructions in various modules to perform their respective tasks;

7. memory 115 to store the instructions of the modules to be executed by the processor 113, and operation data;

8. a location module 117 to prepare the location information received from terminals 200 and 300 into certain formats, such as converting received position coordinates into ordinary, human-readable address, such as using geo-coding services, for instance, the one from GOOGLE; and

9. an account module 119 to maintain profiles for the users of terminals, including user ID, age, sex, geographical area, membership, payment information, etc. for users such as users 2 and 3, the instructions in this module will perform tasks such as formatting, comparing, read/write into memory, etc.

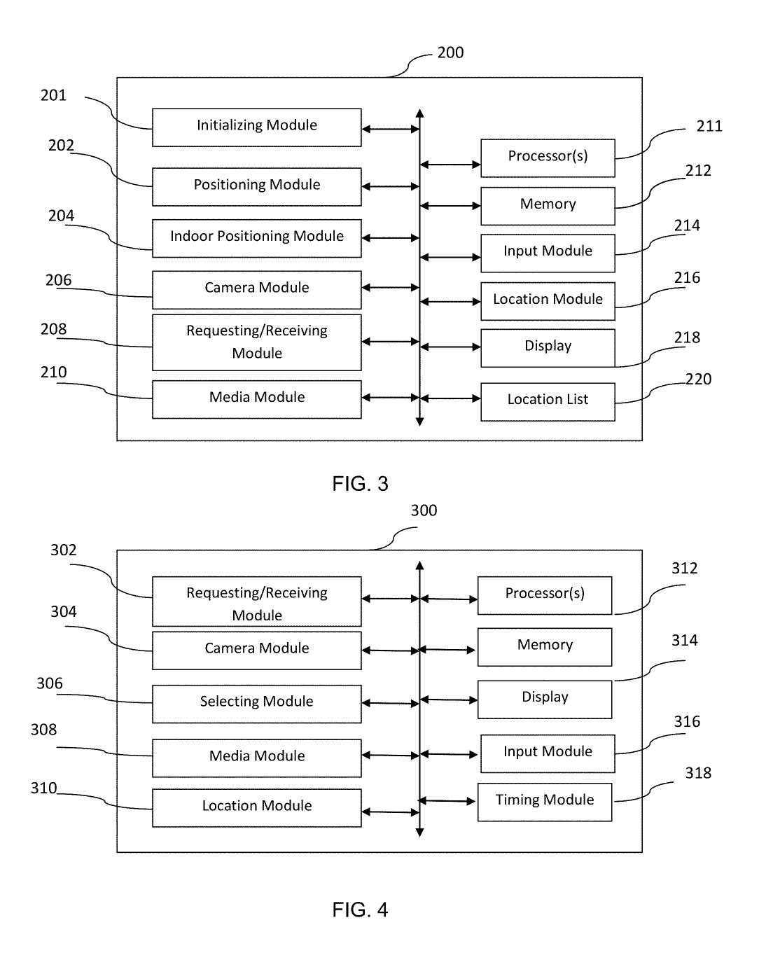

FIGS. 3 and 4 show exemplary functional blocks for terminals 200 and 300. Although some blocks of terminal 200 are different from some for terminal 300, however, all blocks in FIGS. 3 and 4 can be all contained in each terminal 200 or 300, and some of them can be distributed as a single application, or separate and different applications for each terminal 200 and 300. In one embodiment, terminal 200 can also function as terminal 300, and vice versa.

In FIG. 3, terminal 200 has the following modules, according to an embodiment:

1. a positioning module 202 to acquire position information, such as coordinates from an positioning unit, such as a GPS device (not shown) for terminal 200. The positioning module 202 is to acquire positioning coordinates to be transmitted to device 100 for displaying the location of terminal 200 for terminal 300;

2. a indoor positioning module 204 for getting indoor positioning information from indoor positioning devices (not shown) when terminal 200 is in an indoor environment, especially when the indoor position information can be translated into a format understandable by device 100 and terminal 300, this information will provide more accurate location of terminal 200;

3. a camera module 206 for shooting video or images of the user 2 of terminal 200 for video chat, or shooting other videos or images, this module includes a camera, and necessary instructions to control the camera and other components of terminal 200;

4. a requesting/receiving module 208 to communicate with device 100, e.g., to send availableness report, or to send/receive live video stream, images etc., this module includes instructions for listening, setting up connections, and transmitting data;

5. a media module 210 to prepare video, audio streams for live video chat, and play videos on the display 218, this module may buffer, encode and decode according various video stream or related protocols, it may also includes code to control other hardware components to operate with video playback and other related tasks;

6. a processor(s) 211 to execute instructions for the modules in terminal 200;

7. memory 212 to store all instructions for the modules;

8. an input module 214 to receive input from the user 2 to operate terminal 200;

9. a location module 216 to prepare location information of terminal 200 to send to device 100, where the location module 216 can take data from the positioning module 202, and the indoor positioning module 204, or alternatively, can set a specific location selected from a location list 220 that is stored in the memory 212, or takes input from the input module 214 by the user 2; and

10. a display 218, which is controlled by the processor 211 to show user interfaces, and live video chat screens.

11. an initializing module 201 contains instructions to initializing some modules to perform certain tasks when an application containing some of the modules in terminal 200 is initialized to run in terminal 200.

FIG. 4 shows functional blocks for terminal 300, in accordance with one embodiment. It contains a selecting module 306 for selecting terminal 200, based on its locations and/or availableness to communicate with, and a timing module 318 to time the duration of various on-going events, such as the live video chat between terminals 200 and 300. Modules, 302, 304, 308, 310, 316 are the same or similar to those in FIG. 3, in terms of structures and/or functionalities. Terminal 300 also has a processor(s) 312 to execute instructions for the modules, and a display 316 to user interfaces, and live video chat screens.

The principles of the live video chat using device 100 and terminals 200 and 300 are illustrated by the following flowcharts together with some schematic diagrams, based on exemplary embodiments. The flowcharts show only exemplary tasks in embodiments to describe the principles of the methods, and the order of the tasks is not necessarily fixed as shown, might be altered, and certain steps might be omitted without departing from the principles of the invention.

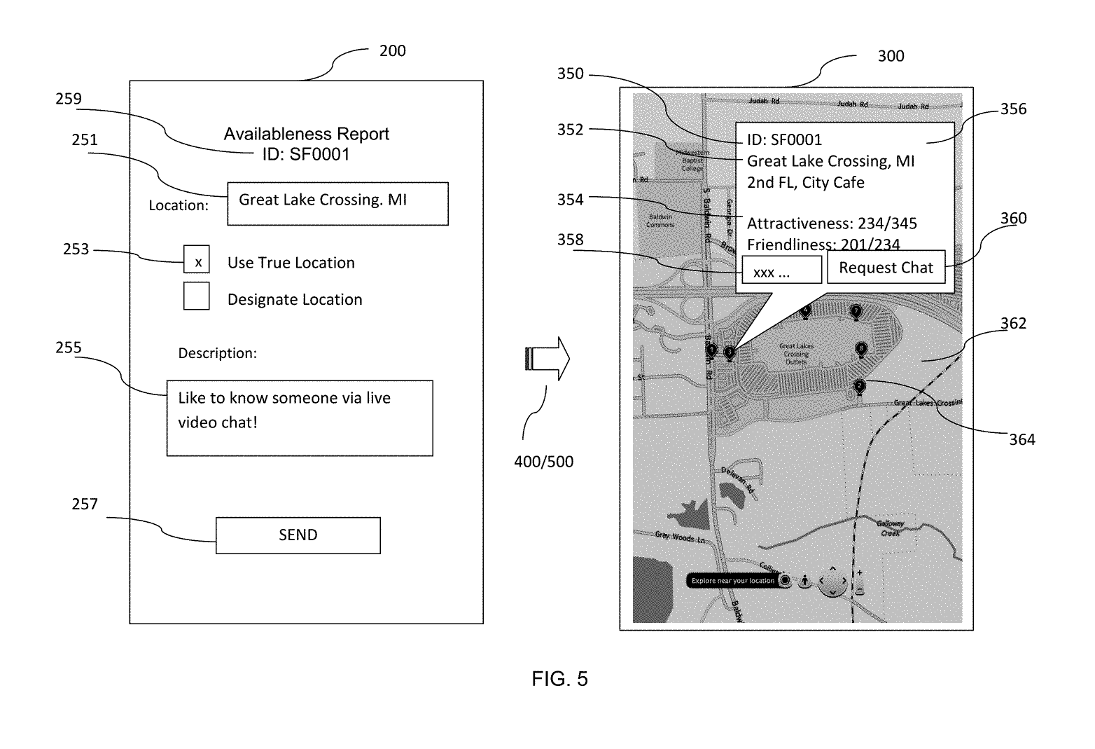

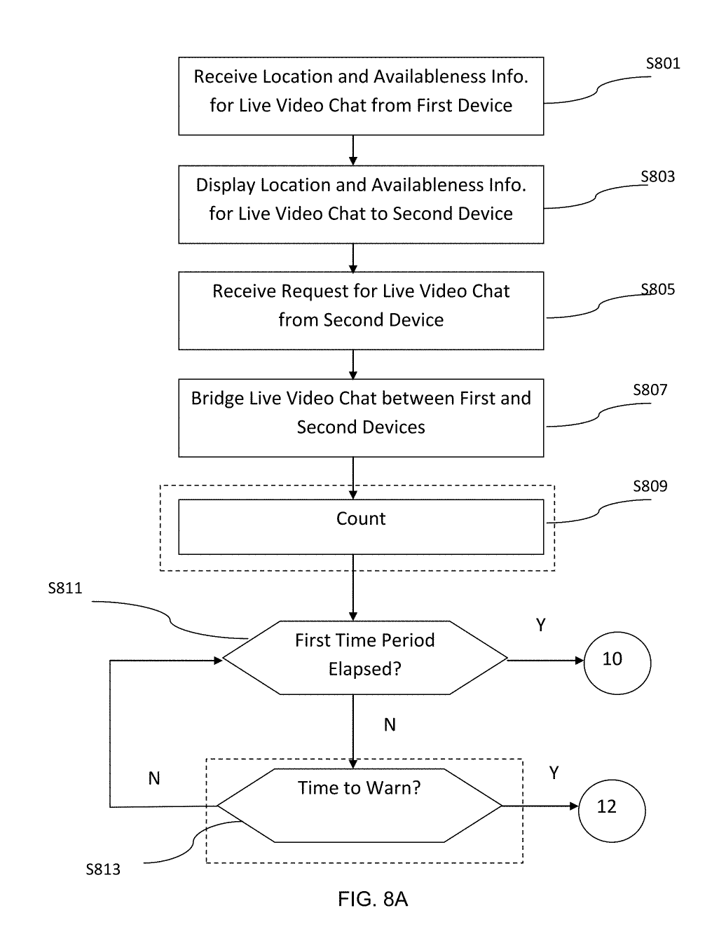

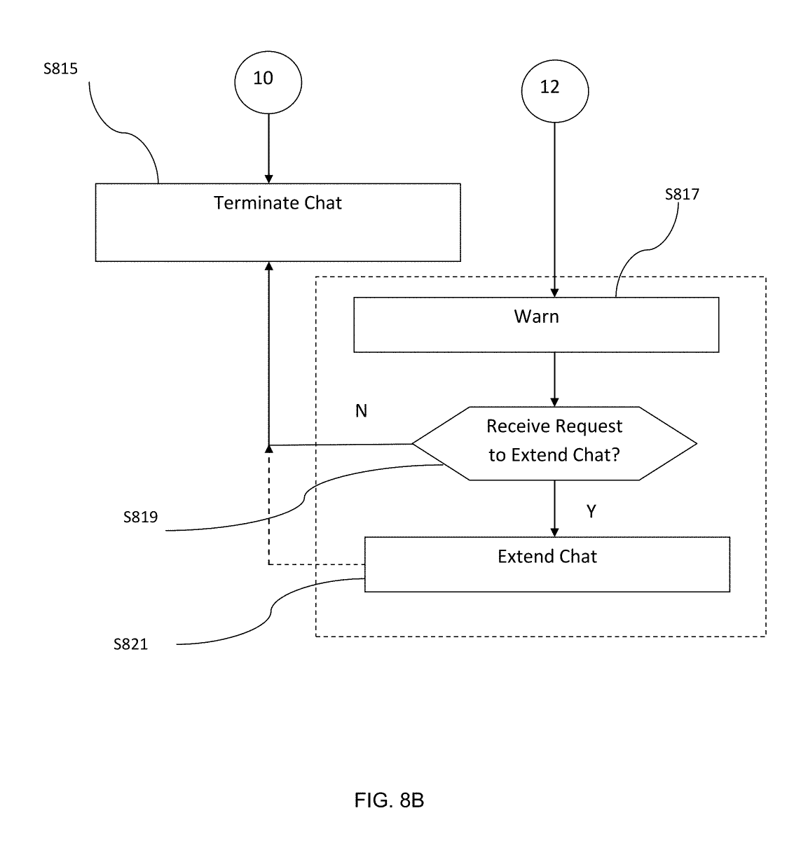

Referring to FIGS. 8A and 8B, in block S801 the receiving module 101 receives the availableness and location information from terminal 200 that terminal 200 (or the user 2) is ready to have a live video chat. The available information may be prepared by a user interface as depicted by FIG. 5, on the left, the display 218 shows a screen for the user 2 to fill out, it is showing the user ID 259 (“SF0001”) for example, registered with device 100, and a location box 251 for the user to enter the location he desires others to see, or optionally he can use the real positioning coordinates, by selecting options 253, or choose to use a pre-set list of addresses from the location list 220. The list 220 may look like:

Time Square, NYC, 40°45′23″N 73°59′11″W

Grand Central, NYC, 40°45′10.08″N 73°58′35.48″W

By using the list 220, the user 2 does not have to reveal his real location, especially when he is at home. By using options 253, the user can choose either use the true location, e.g., by GPS positioning or entering a true location description. If the user agrees to reveal his real location, then the positioning module 202 will try to get positioning coordinates from outdoor positioning systems, e.g., satellite signals, such GPS signals if they are available in tasks, however, if outdoor signals are not available, then terminal 200 will try to get last saved position coordinates, for example, the set of date saved just before entering a building. Furthermore, as an option, if indoor position information is available, the indoor positioning module 204 will try to get indoor position information from the indoor. If the user wants to use the pre-set location list 220, he can select one from the location list 220. Finally, the user 2 can choose to enter description of location in box 251 of FIG. 5, the location module 216 can prepare the location information, and then the requesting/sending module 208 sends the data to device 100 with the user 2 click button 257 of FIG. 5. Optionally, the user 2 can also add comments in a box 255 to further describe his situation for being available to have a live video chat.

Going back to FIG. 8A, in block 5803, the location module 117 processes the location data received from terminal 200, and the account module 119 process the user ID to retrieve necessary profile about the user 2. The sending module 103 then sends the data to terminal 300 to display the availableness and the location of terminal 200 on the display 314. The format of displaying can vary, it can be in a vertical listing format by listing all available terminals with location information, and/or user profiles, or displaying the data on a map, like the map 307 in FIG. 1 with pinpoint 303, in another format, or in a map 362 in FIG. 5, on the right, with pinpoints 364. To be specific, the mapping module 105 will combine the position coordinates and a relevant map (e.g., map tiles) from a map database (not shown) and tag or mark the map by marking location and other information for terminal 200. Alternatively, device 100 can just provide location information and relevant date, except the map tiles that would be provided by terminal 300 itself, and terminal 300 will combine the data with the map and display them.

In block 5805, terminal 300 may has a user interface like the one shown in the right part of FIG. 5, on its display 314, the user interface may have a map 362 displaying pinpoints 364 of available terminals for live video chat, including terminal 200. In case the user 3 selects terminal 200, a popup window 356 might show information regarding terminal 200, such as the user ID 350 (same as the user ID 259) of the user 2, and location 352 (same as the location 251/253) which may also includes indoor location, if available. Additional description 358 can also be provided, taken from the description 255 from terminal 200. The user 3 may trigger request to have a live video chat with the user 2 of terminal 200 by clicking button 360.

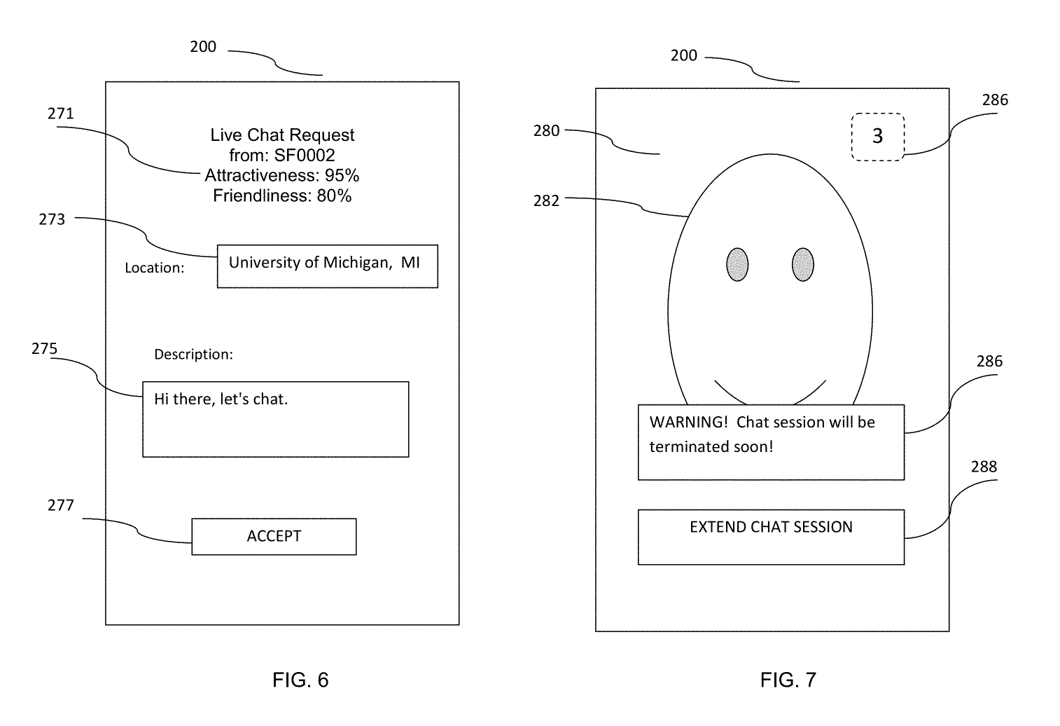

A user interface as shown in FIG. 6 might be displayed in terminal 200 on its display 218. The interface may include the user 3′s profile 271, such as a user ID “SF0002,” the location 273 of terminal 300, and any additional comments 275 from the user 3. If the user 2 is willing to have a live video chat, then he can click button 277 to start the chat. Once the request from terminal 300 is accepted by terminal 200, then in block 5807, device 100, the video module 107, together with the receiving module 101 and the sending module 103, will bridge a live video chat between terminals 200 and 300 being used by users 2 and 3.

During the live video chat, in block 5811, the timing module 111 will determine whether a first pre-set time period has elapsed since the start of the chat, if affirmative, in block S815, the video module will terminate by either stopping providing video streaming or cutting off the live video communications between device 100 and terminals 200 and 300. The reason of doing this is that in many real world situations, a person in a chat is often hesitant to terminate a conversation even if the person really wants to. Therefore, having device 100 to terminate the live video chat will relief the parties in the chat from the burden of terminating the chat. This is also important in case the users 2 and 3 are totally strangers, and they meet for the first time via the live video chat. People can experience pressure or fear when talking to a stranger for long time, e.g., more than 30 seconds, or so. Therefore, the purpose here is to keep the chat within a short period of time, e.g., less than 30 seconds. It could be as short as 1 second, or a few seconds, or 10, 15, 30, or 60 seconds, in some case, for instance, chatting between 2-10 seconds would be good for an initial chat. When a user feels less pressure in talking to a person online face to face, he tends to use the live video chat more often, and willing to browse more people. In one embodiment, signal latency (in some case, can be 150-300 ms) in bridging the video chat due to networks or other technical reasons, will not be counted in timing the short period of time for chatting.

Alternatively, the live video chat can be terminated by the terminals 200 and 300 themselves. The timing module 318 in the terminal 300 (or a similar module in the terminal 200) can track the first pre-set time period and produce a signal to the processor 312 to control the media module 308 or the requesting/receiving module 302 to terminate the chat.

In optional tasks 5813 and 5817, the timing module 111 may send a signal before the first pre-set time period has elapsed to let device 100 to warn the user 2, whiling watching the live image 282 of the user 3, that the chat session to going to end soon. Referring to FIG. 7, the users in the chat may see on their terminals a screen 280 showing a warning sign 286, or a count-down sign 290 to inform the users of the upcoming ending of the chat. A user with certain privilege or higher privilege (explained later) may be able to extend the chat session for a certain period of time by clicking the button 288, for instance.

If a valid (such as one from a user with higher privilege) request to extend is received by the receiving module 108, the chat will be extended in tasks S819 and S821. Otherwise, the chat will be terminated as in task S815.

A first chat between users 2 and 3 may be conducted via non full-ledged videos other than normal or full-fledged videos. Here, a full-fledged format of video is, for example, a color video with an audio component, or a video made by terminal 200 or 300 in its normal or original settings; and the other hand, a non full-fledged video is, for instance, a black and white video, or a video with its original color components altered, for example, to make video with a single color or sepia effects, or a video without its audio component or made with the microphone muted, or a video made with a pre-determined resolution or pre-determined frames per second (FPS), e.g., at a lower resolution or FPS rate.

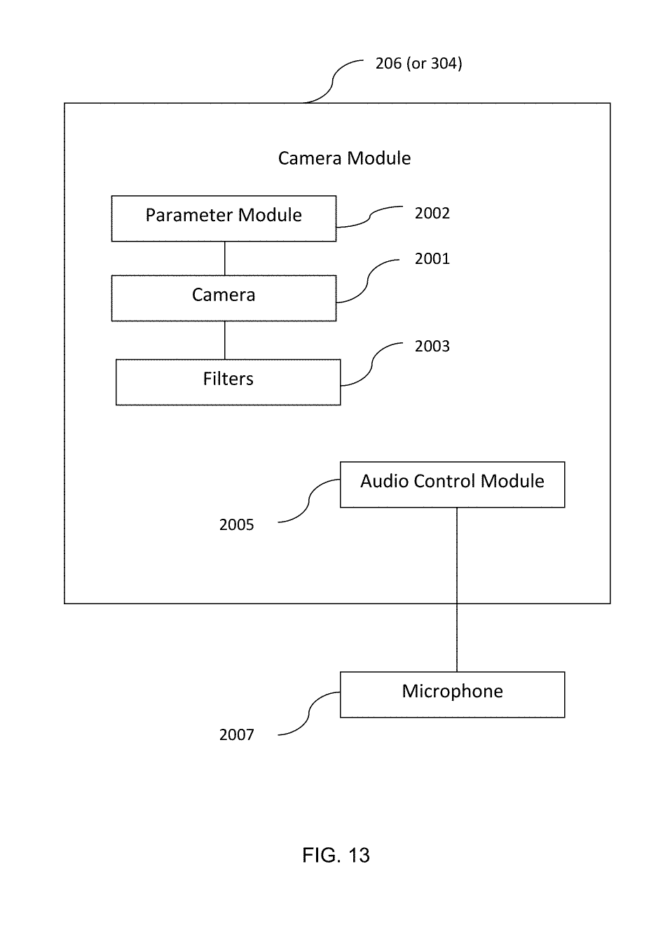

Referring to FIG. 13, according to an embodiment, the camera module 206 or 304 includes a camera 2001 for shooting video, a set of filters 2003, such as sepia filters or black and white filters, or other filters to alter colors for videos to be made by the camera 2001, and a parameter module 2002 to control the settings for resolution and FPS of the camera 2001. As an example, the filters 2003 can be realized by software, in ways similar to those used by, such as OpenGL libraries, some commercial video software, some ANDROID/JAVA packages, etc., which provide real-time effects on video making. The camera module 206/304 may also include an audio control module 2005 to receive instructions, for example, from the one or more processors 211, and control the settings of a microphone 2007 of terminal 200 (or 300). The audio control module 2005 can, for instance, turn off or on the microphone 2007 in making video by the camera 2001, or alter the audio effects to make the audio components distorted such that the voice of user 2 becomes harder to recognize by user 3.

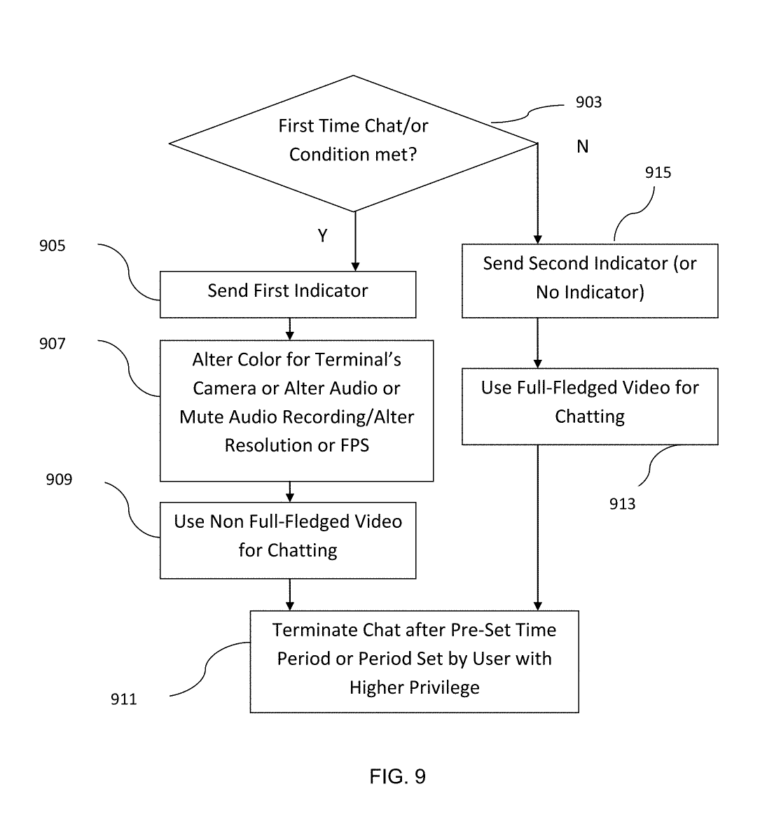

Referring to FIG. 9, in block 903, when device 100 first receives a request from terminal 300 being used by user 3 for a live video chat with user 2 using terminal 200, it may look up the users 2 and 3's profiles via the account module 119 for a chatting history between the two to determine whether this would be the first time the two users have a live video chat or the first live video chat after a pre-determined time period since last live video chat between the two. The pre-determined time period chat may be, for instance, one day, one week, one month, six months, or some periods in between. If determined so, then in block 905, the account module 119 will control the processor(s) 113 to send, via the sending module 103, to both or either or of terminals 200 and/or 300 a first indicator or instruction to instruct the camera modules 206 and/or 304, in block 907, for instance, to choose certain filers 2003 to alter colors in making video to order to get a non full-fledged video for chatting, or/and control the audio control module 2005 to mute the microphone on terminals 200 and/or 300 to make muted video for chatting, or control the parameter module 2002 to alter the resolution or FPS of the camera, e.g., can set the resolution or FPS at a pre-determined lower than normal level, for instances, a resolution lower than MPEG 1, or 204×320, or a FPS rate lower than 24 FPS. Here the filters refer to built-in filters with the camera module 206 or 304, like sepia, or black and white filters. Broadly, the filters can refer to a software way, including embedded software in hardware, to make video in a non full-fledged format.

In block 909 of FIG. 9, the non full-fledged video so made as described above will be used in the video chat bridged by the video module 107 of device 100.

Alternatively, in block 903, if it is determined that users 2 and 3 had video chat before that was happened within the pre-determined time period, the flow will goes to an optional block 915, where a second indicator might be sent out via the sending module 103, to both or either of terminals 200 and/or 300 instruct the camera modules 206 and/or 304 to make a full-fledged video or not to alter the video format of the video-making settings for chatting, or the block 915 can be totally ignored, or omitted, i.e., no second indicator will be sent out at all. In block 913, the video module 107 of device 100 will bridge the video chat using full-fledged video format or non-altered format by either terminal 200 or 300.

In the end, in block 911, ensuing either from block 909 or 915, when the timing module 111 has determined that a pre-set time period, e.g., from 1-30 seconds, which is set either by the pre-set rules in device 100, or by user 2 or 3 whoever has a higher privilege in his or her profile (to be explained later), has elapsed. The video module will terminate the video chat between users 2 and 3.

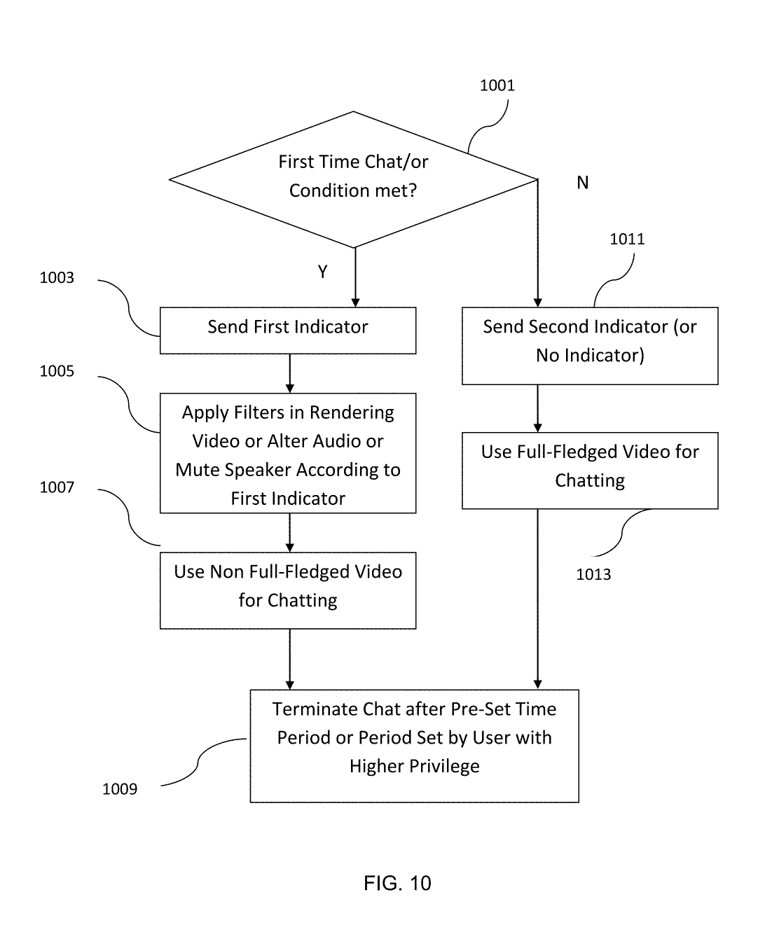

FIG. 10 is an embodiment in rendering a video chat between user 2 and 3 using terminals 200 and 300 by device 100. Block 1001 performs a similar function as block 903 in FIG. 9. If a non full-fledged video is needed as determined by block 1001, then in block 1003, a first indicator is sent out to either terminal 200 or terminal 300 to control the terminal that received the first indicator to render the video signal received from the other terminal in a non full-fledged format.

Based on the first indicator, either terminal 200 or 300 that has received the first indicator can convert a full-fledged video into a non full-fledged video. In case of conversion by the media module 210 of terminal 200, for instance, media module 210 can convert the full-fledged video into a non full-fledged video via a software way or a hardware way, or a combination of them, per instructions contained in the first indicator. A similar or the same function in the media module 308 can be expected in terminal 300 for the same role when needed. In a software way, instructions included in media module 201 can filter out the audio component of the received video from terminal 300 or mute the sound, therefore making the video being played muted and then rendering the video on the display 218 in a non full-fledged format; in yet another embodiment, the first indicator may contain instructions to alter the color components in the received video signals from terminal 300, for instance, by applying various filters, in order to render the video signals on the display 218 in a non full-fledged video format. Video-processing technologies and approaches, for instance, those similar to the underlying technologies in various video-editing software, such as those in UBUNTU, or some commercial software, can be used to convert a full-fledged video into a video of a desired or pre-determined format.

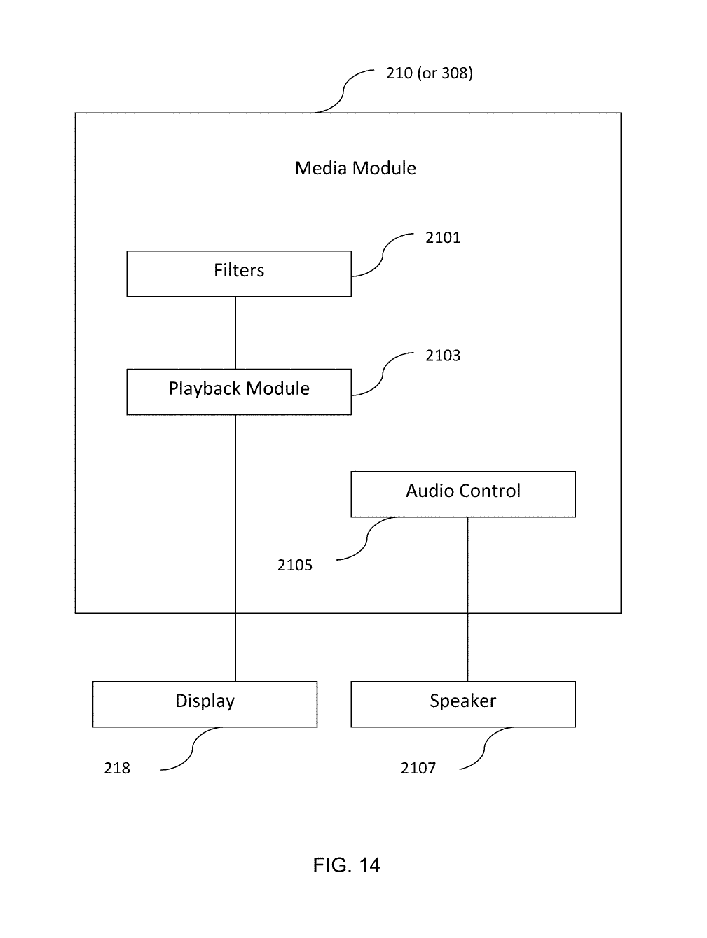

In block 1005, the media module 210 being executed by the processor(s) 211 implements the first indicator to render the video signals on the display 208 in a non full-fledged format. Exemplary details for rendering the video signals received from terminal 300 are illustrated in FIG. 14. The media module 210 (also for 308 for terminal 300, here using terminal 200 for example) can contain a plurality of filters 2101, a playback module 2103 to render video on display 218, and an audio control 2105 for control a speaker 2107 of terminal 200. Depending on the contents of the first indicator received, the media module 210 can either pick up a filter of the filters 2101 to filter out certain color components from the video signals received, or use the audio control 2105 to mute the speaker 2107 in rendering the video signals. In one embodiment, the filters 2101 can be realized by software. In another embodiment, the audio control 2105 can alter the audio components of the received video signals to render the audio for the received video signals in a distorted way.

In block 1007, the media module 208 will playback the altered video signals from terminal 300 on the display 208 in chatting with user 3. Blocks 1011, 1013, and 1009 performs tasks respectively corresponding to those as described for blocks 915, 913, and 911 in FIG. 9.

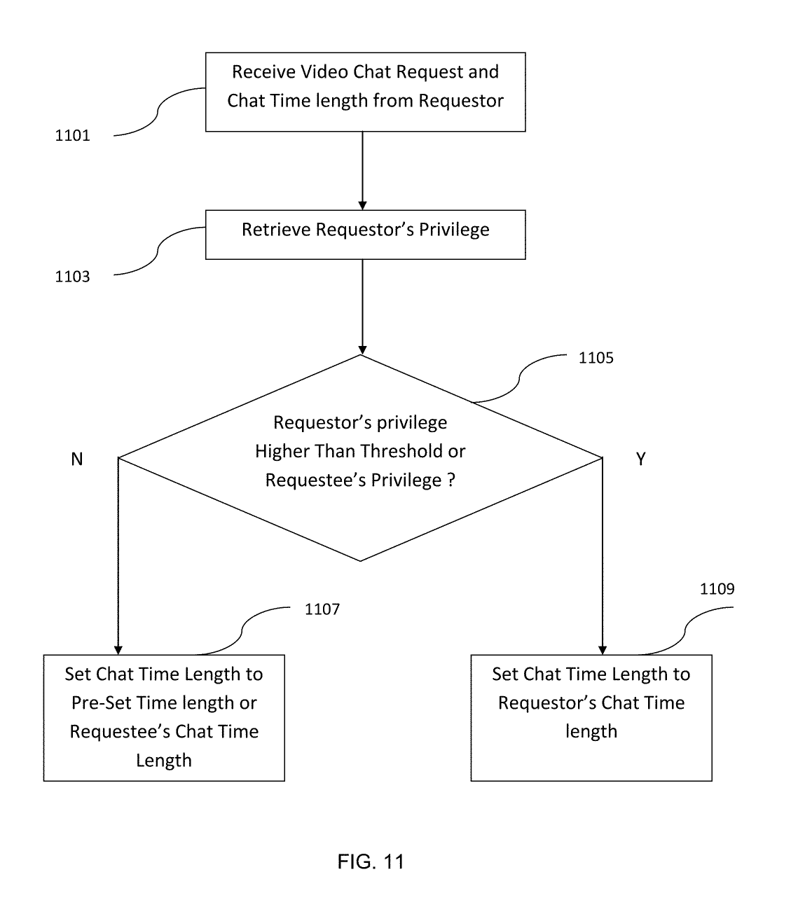

The length of time for chatting can be set either by device 100 as a pre-set value or by a user in the chat. As an exemplary embodiment, FIG. 11 illustrates how the length of time or the period of time for a chat is set. In block 1101, a request for chat is received by the receiving module 101 of device 100 as the server from, for instance, user 3 using terminal 300, as the requestor for chat with user 2 using terminal 200 as the requestee, together with a length of time from the requestor. In block 1103, the account module 119 will look up both the requestor and the requestee's user profiles stored in the memory 115, if, in block 1105, the account module determines that the requestor's privilege in the profiles is higher than a threshold level or than the requestee's privilege, then, in block 1109, the length of time for the chat will be set by the value set by the requestor, otherwise, in block 1107, the length of time for chat will be set to a default pre-set period of time, which may be stored in the memory 115, or alternatively, if the requestee has a higher privilege, and he or she has set a value for the chat, then the period of time for chat will be set by the requestee.

Each user profile can have a different privilege in determining some parameters for chatting, such as the period of time for chatting, the format of video chat the other user in char could experience, etc. In one embodiment, a paid account by a user may be a threshold for such privileges, in another embodiment, a payment level may be used in determining level of privilege a user can have in comparing with other users for a video chat. Also, the frequency of conducting video chats may also be used as a factor to get a higher privilege. Some examples in determining result of comparing privileges of the users for a live chat, paid user usually has higher privilege the a non-paid user; a higher level of paid membership has a higher privilege; a senior account holder has a higher privilege that a junior account holder.

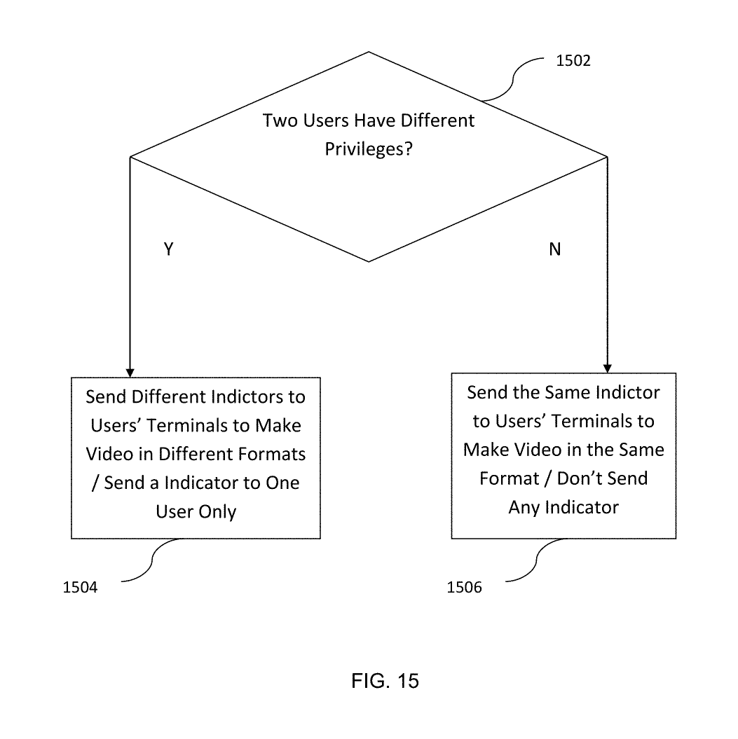

In case it is determined that the two users for a video chat have different privileges for chatting, for instance as determined in block 1502 of FIG. 15, then different indicators can be respectively sent to terminals used by the two users to make video in different format per pre-sent rules in block 1504. As an exemplary pre-set rule, a user with higher privilege will be able to see more information (e.g., more color, voice, higher quality video, etc.) about the other user than the other user would. If it is determined in block 1502 that the two users have the same privilege for a video chat, the same indicator or no indicator at all will be sent to the two terminals such that the video made by the two terminals will not be altered for this video chat.

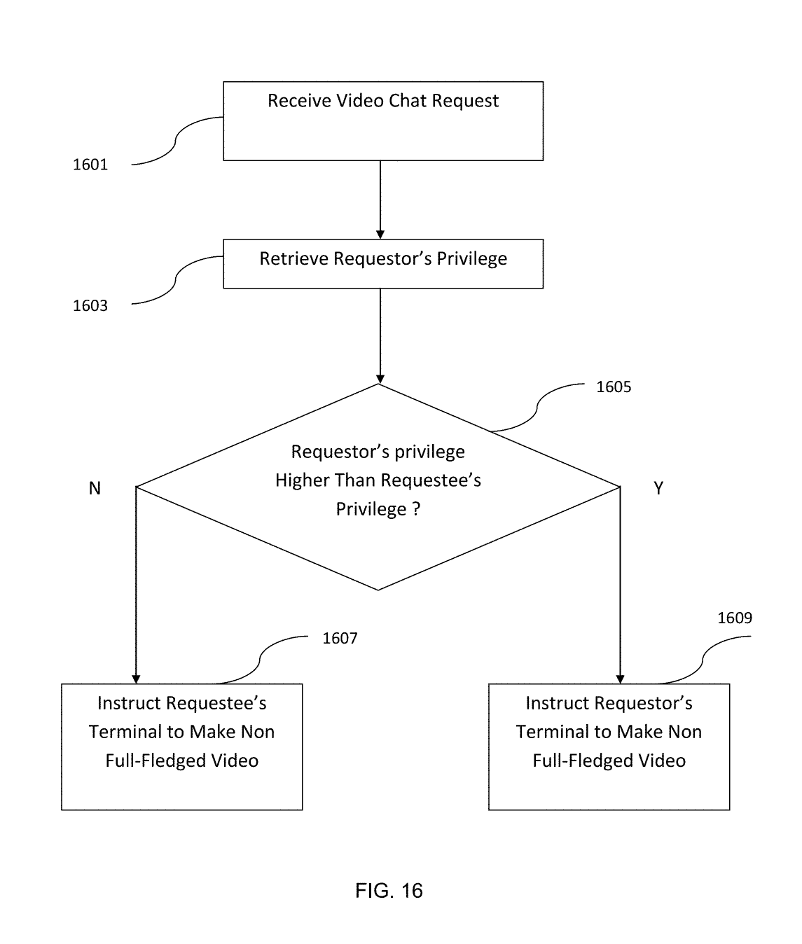

In another embodiment for two chatters with different privileges for a chat as shown in FIG. 16, when user 3 as requestor requests via device 100 to video chat with user 2 as requestee in block 1601, the account module 119 of device 100 will look up the requestor and requestee's privileges for chat stored in the memory 115 in block 1603, and determine who has a higher privilege for the chat in the decision block 1605. If it is determined that the requestee has a higher privilege that the requestor's, then in block 1607, terminal 200 being used by user 2 (the requestee) will get instruction from device 100 to make non full-fledged video of the requestee to be used in chatting with the requestor; on the other hand, if the requestor has a higher privilege than the requestee's, then in block 1609, terminal 300 being used by user 3 (the requestor) will have the instruction from device 100 to make non full-fledged video of the requestor to be used in chatting with the requestee. This process of using non full-fledged video for video chat can be employed for the first-time chats, or non first-time chats.

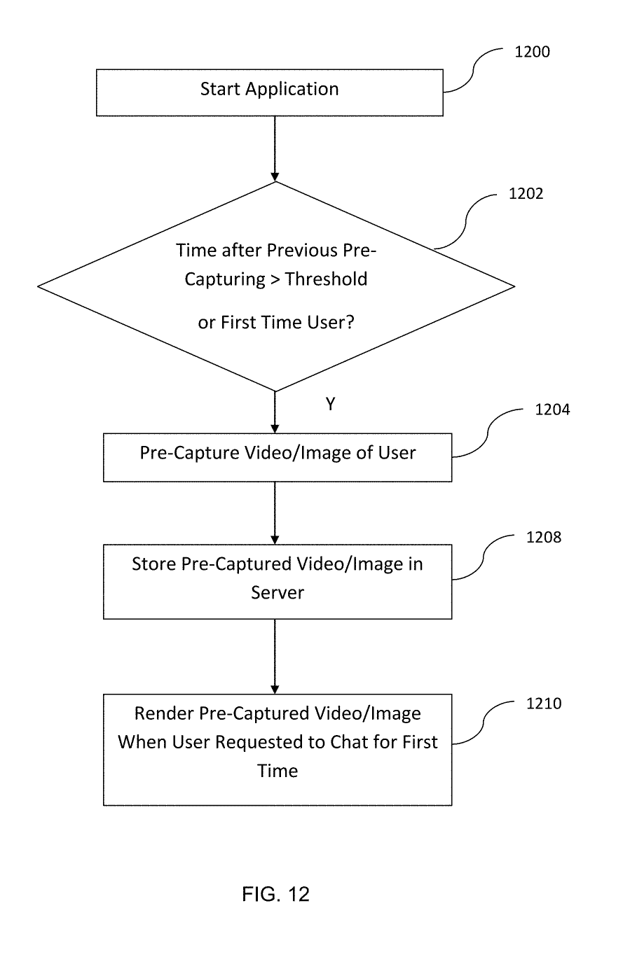

For a quick screening of people to chat with, a pre-captured media, either being a video or image, or other format of information, of a user of a terminal can be stored in the memory 115 of device 100 for another user to view before actually requesting a chat with the user whose pre-captured media has been reviewed by the user requesting a chat. In one embodiment, some modules in FIGS. 3 and 4 can be packaged into a software package as an application installed in terminal 200 and 300. FIG. 12 shows an exemplary process for recording and using a pre-recorded media of a user in a pre-chat situation. When a user starts the application in block 1200, his usage history of the application will be checked in block 1202, whether this is his first time to use the chat application or a pre-set period of time has elapsed since his use of the application last time, in order to, at least, keep the pre-captured media current or nearly current to date. Taking user 2 using the application installed in terminal 200 as an exemplary user, when user 2 starts the application, the initializing module 201 will inform the requesting/receiving module 208 to communicate with device 100 via the receiving module 101 about the starting of the application by user 2, to get usage history of user 2. The account module 119 will looks up the usage history of user 2 stored in memory 115. If it is determined by the account module 119 that this is the first time that user 2 uses the application, or a pre-set period time has elapsed since the last time user 2 used the application, then a first instruction will be sent back to terminal 2 via the requesting/receiving module 208 to instruct the application to request user 2 to pre-capture a media about user 2, otherwise, a second instruction will be sent back to indicate that there is no need for a pre-captured media at the moment. In block 1204, the processor(s) 211 will instruct the camera module to capture video of user 2 of a pre-set length of time, or an image of user 2. The captured media of user 2 will be sent back to device 100 to be stored in the memory 115, as performed in block 1208. In block 1210, when user 2 is requested by a user using another terminal, e.g., user 3 using terminal 300, to have a video chat for the first time, device 100 will provide user 3 the pre-captured media of user 2 for user 3 to review and decide whether a real-time video chat is stilled needed. The reason to ask for a frequent pre-captured media after very pre-set period of time, such as from a few days to maybe six months or so, is that the relevant current video or image of a user can provide more current information about the user, thus improving the effectiveness of screening for chatting partners.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A device for video chatting, comprising:
one or more processors;
non-transitory memory; and
a plurality of modules, wherein the modules are stored in the non-transitory memory and comprise instructions to be executed by the one or more processors to bridge video chatting; and when executed, the instructions of the modules cause the one or more processors to:
receive a request from a first terminal being used by a first user to video chat with a second user using a second terminal;
after determining that a pre-set condition is met, send an indicator to one of the first and second terminals to instruct the terminal that has received the indicator to alter color components of a video either received or made by the one terminal to be used for the video chat.

2. A device for video chatting, comprising:
one or more processors;
non-transitory memory; and
a plurality of modules, wherein the modules are stored in the non-transitory memory and comprise instructions to be executed by the one or more processors to bridge video chatting; and when executed, the instructions of the modules cause the one or more processors to:
receive a request from a first terminal being used by a first user to video chat with a second user using a second terminal;
retrieve privileges of the two users for video chatting;
after determining that the privileges of the two users are different, send an indicator to only one of the two terminals, according to a pre-set rule, to instruct the one terminal to make non full-fledged video in a pre-determined format for the video chat; and
render the non full-fledged video made by the one terminal according to the indicator to the other terminal in bridging the video chat.

3. The device of claim 2, wherein after determining that the privilege of one of the two users is higher that of the other user, the pre-set rule is that the indicator is to be sent to the terminal of the one user with the higher privilege.

4. The device of claim 3, wherein the one user is determined to have the higher privilege due to the one user's paid membership for the video chatting.

5. The device of claim 3, wherein the one user is determined to have the higher privilege due to the one user's higher level in paid membership for the video chatting.

6. The device of claim 2, wherein determining that the privilege of one of the two users is higher than that of the other user, the pre-set rule is that the indicator is to be sent to the terminal of the one user with the higher privilege, and the terminal that has received the indicator makes non full-fledged video to be used in the video chatting.

7. The device of claim 2, wherein after determining that the privilege of one of the two users is higher than that of the other user, the pre-set rule is that the indicator is to be sent to the terminal of the one user with the lower privilege, and the terminal that has received the indicator converts video made by the other terminal into non full-fledged video and renders the non full-fledged video to the one user with lower privilege.

8. A device for video chatting, comprising:
one or more processors;
non-transitory memory; and
a plurality of modules, wherein the modules are stored in the non-transitory memory and comprise instructions to be executed by the one or more processors to bridge video chatting; and when executed, the instructions of the modules cause the one or more processors to:
after receiving a first request from a first terminal used by a first user to video chat with a second user using a second terminal, render pre-recorded media of the second user to the first terminal, wherein the pre-recorded media was recorded at a time an application running on the second terminal for the video chat was started by the second user upon a condition that the second user used the second terminal running the application for the first time for video chatting or had not been pre-recorded for such pre-recorded media for a first pre-set time period since previous recorded media;
after receiving a second request from the first terminal by the first user for a video chat with the second user after the rendering of the pre-recorded media of the second user, retrieve privileges of the two users for video chatting;
after determining that the privileges of the two users are different, send an indicator to only one of the two terminals, according to a pre-set rule, to cause the one terminal to make non full-fledged video in a pre-determined format for the video chat; and
render the non full-fledged video made by the one terminal according to the instruction to the other terminal in bridging the video chat.

9. The device of claim 8, wherein the pre-recorded media is a video of the second user.

10. The device of claim 8, wherein the pre-recorded media is an image of the second user.

11. The device of claim 8, wherein after determining that the privilege of one of the two users is higher that of the other user, the pre-set rule is that the indicator is to be sent to the terminal of the one user with the higher privilege.
